(19) United States
(12) Patent Application Publication
(10) Pub. No.: US 2010/0101412 A1
(43) Pub. Date: Apr. 29, 2010

(54) METHOD AND SYSTEM FOR REMOVING ALKYL HALIDES FROM GASES

(75) Inventors: Peter J. Joyce, Mullica Hill, NJ (US); Roman Bielski, Coopersburg, PA (US)

Correspondence Address: RATNERPRESTIA, P.O. BOX 980, VALLEY FORGE, PA, 19482, US

(73) Assignee: Value Recovery, Inc., Bridgeport, NJ (US)

(21) Appl. No.: 12/256,921

(22) Filed: Oct. 23, 2008

(51) Int. Cl. B01D 53/02

(52) U.S. Cl. 95/92

(57) ABSTRACT

An alkyl halide such as methyl bromide can be effectively removed from a gas stream by passing the gas stream through a bed of adsorbent at a relatively low temperature to adsorb the alkyl halide onto the adsorbent, desorbing the alkyl halide at a higher temperature to produce a smaller volume of gas containing the alkyl halide in more concentrated form, and then reacting the alkyl halide with a nucleophile contained in a liquid phase by contacting this smaller gas volume with such liquid phase.

### FIELD OF THE INVENTION

This invention relates to the removal and destruction of alkyl halides from a gas. In particular, the invention provides a method as well as a system for effectively and efficiently dealing with the large volumes of methyl bromide-contaminated air generated in connection with fumigation operations.

### BACKGROUND OF THE INVENTION

Many alkyl halides possess a degree of toxicity, sometimes very high toxicity. For example, the toxicity of methyl bromide is so great that it has been used for many years in the extermination of insects in mills, warehouses, vaults, ships, freight cars, imports and exports, and also as a soil fumigant for use by growers of strawberries, tomatoes, and other crops. Other applications include treatment of ships to remove undesirable rodents and insects and the treatment of foods such as fruits (including dried fruits), grain, flour, nuts, and tobacco products to remove potential pests. Additionally, methyl bromide has been successful in fumigation against various microorganisms including fungi and bacteria. Recently, methyl bromide has been advocated as the most effective agent against anthrax (Bacillus anthracis). Its virtues include that it is nonflammable and not explosive, has a very high diffusivity and permeability, and has been used safely for over 60 years.

Unfortunately, release of methyl bromide into the atmosphere is generally accepted to cause ozone layer depletion that can result in increased incidences of skin cancer. Direct release of methyl bromide into the environment is also a concern to workers and bystanders who may be harmed by its toxic effects. Thus, there is a need for methods of disposing of methyl bromide without releasing it to the atmosphere. There is also a general need for methods of rapidly and economically removing volatile alkyl halides such as methyl bromide from gas streams.

In particular, methyl bromide is widely used for large scale quarantine fumigation of products such as produce and other agricultural goods, with the chambers utilized in such applications typically ranging from about 850 to about 7000 cubic meters (about 30,000 to about 250,000 cubic feet) in size. The initial methyl bromide concentration employed in these chambers generally is from about 24 to about 128 grams per cubic meter (about 1.5 to about 8.0 lbs/1000 cubic feet). Current USDA-APHIS regulations for imports and exports require that the aeration step needed to remove methyl bromide from a chamber following fumigation be a minimum of four turnovers per hour of fresh air in order to reduce the concentration of methyl bromide below 5 ppmv (parts per million by volume). Sweeping the methyl bromide out of a fumigation chamber to aerate the chamber in this manner using fresh air results in the generation of very large volumes of methyl bromide-contaminated air. Removing the methyl bromide from such large gas volumes in a cost-effective manner has proven to be very challenging.

### SUMMARY OF THE INVENTION

In one aspect of the invention, a method of removing an alkyl halide from a first gas volume is provided. This method comprises:

contacting the first gas volume with an adsorbent capable of adsorbing the alkyl halide from the first gas volume within a first temperature range, thereby producing an alkyl halide-containing adsorbent;

contacting a volume of air that is smaller (preferably, much smaller) than the first gas volume (for example, the air volume may be less than 20% or less than 3% or less than 0.5% of the volume of the first gas volume) with the alkyl halide-containing adsorbent within a second temperature range that is greater than the first temperature range and effective to desorb at least a portion of the alkyl halide from the adsorbent, thereby producing a second gas volume containing the alkyl halide and having a volume less than the volume of the first gas volume and an alkyl halide concentration greater than the alkyl halide concentration of the first gas volume; and

contacting the second gas volume with a liquid phase comprising water and a nucleophile capable of reacting with the alkyl halide to produce a purified gas stream.

In another aspect, the present invention provides a system for removing an alkyl halide from a gas volume, the system comprising:

a) an adsorption/desorption unit comprising an adsorbent capable of adsorbing the alkyl halide from the gas volume; and

b) a reactor assembly comprising a reaction vessel containing a liquid phase comprised of water and at least one nucleophile.

The present invention thus affords a practical method for removing and destroying fumigation agents such as methyl bromide from fumigation aeration streams or discharge gases (even where such streams or discharge gases are quite large in volume) which is relatively inexpensive, effective, safe and executable on-site such that transportation of methyl bromide-containing wastes to an off-site facility is not necessary. By use of the inventive process, rapid degradation (e.g., within 2 to 24 hours) of an alkyl halide-contaminated gas volume can be achieved, thereby permitting fumigation chamber cycle times to be kept advantageously short and increasing product throughput through the chambers.

### BRIEF DESCRIPTION OF THE DRAWING

FIG. 1 is a schematic illustration of a system employing a method according to one exemplary embodiment of the invention.

### DETAILED DESCRIPTION OF CERTAIN EMBODIMENTS OF THE INVENTION

One step of the present invention comprises contacting a first gas volume containing one or more alkyl halides with an adsorbent capable of adsorbing the alkyl halide(s) within a first temperature range, thereby depositing or condensing the alkyl halide(s) onto and within the confines of the adsorbent and producing an alkyl halide-containing adsorbent. The alkyl halide-containing first gas volume may be obtained from any suitable source. However, the method of the present invention is especially useful for purifying methyl bromide-contaminated gas volumes generated from fumigation operations (i.e., fumigation aeration streams or discharge gases). For example, the first gas volume may be obtained by providing an enclosure defining a confined space to be fumigated (e.g., a fumigation chamber, typically having a volume of from 27 to 8500 cubic meters or about 1000 to about 300,000 cubic feet or more), placing a product (e.g., produce such as fruits or vegetables or wood products that require fumigation) within the enclosure, sealing the enclosure, introducing an amount of an alkyl halide (e.g., methyl bromide) effective to fumigate the product into the enclosure to produce a gaseous atmosphere comprised of air and alkyl halide (in the case of methyl bromide, typically at a concentration of 24 to 128 grams per cubic meter or 1.5 to 8.0 lbs/1000 cubic feet of fumigation volume), allowing the gaseous atmosphere to remain in contact with the product for a length of time effective to fumigate the product to a desired extent, and flushing the gaseous atmosphere from the enclosure using additional air. The concentration of alkyl halide in the gas stream initially exiting from the enclosure will be relatively high, with the alkyl halide concentration in the gas stream exiting from the enclosure thereafter decreasing as fresh air is introduced into the enclosure and used to flush the confined space. In most instances, the decrease in alkyl halide concentration follows a classic exponential decay curve. Deviations from exponential decay concentration behavior can occur when the produce or other goods being fumigated have a very high affinity for alkyl halide.

The adsorbent may be any material or substance capable of effectively adsorbing the alkyl halide from the first gas volume when such first gas volume is contacted with the adsorbent, preferably at a relatively low temperature (e.g., less than 35° C. or at normal ambient temperatures). Solid, particulate adsorbents are preferred. In one desirable embodiment of the invention, carbon (e.g., activated carbon particles) is employed as the adsorbent, although other suitable adsorbents may include zeolites (molecular sieves) and the like. The adsorbent may be contained in a vessel such as a column. For instance, the adsorbent may be in the form of a bed within a vessel arranged such that the first gas volume may be introduced into the vessel and passed through the bed as a stream in either an upflow or downflow manner, thereby allowing the alkyl halide (which is typically in the vapor phase within the first gas volume) to be adsorbed by the adsorbent. The gas stream exiting from the vessel after passing over or through the adsorbent has a reduced concentration of alkyl halide as compared to the alkyl halide concentration present in the gas stream being introduced into the vessel. Typically, the alkyl halide concentration is greatly reduced; in certain embodiments, the alkyl halide concentration in the exiting gas stream is below detectable limits. In other words, during operation of the adsorption step of the present invention, the alkyl halide concentration at the outlet of the vessel is lower than the inlet concentration of alkyl halide.

The contacting of the first gas volume containing at least one alkyl halide with the adsorbent should be carried out within a temperature range that is relatively low. Preferably, the contacting temperature is set as low as possible within the economic constraints of the system being fumigated. In some instances, goods are fumigated at about 40° F. (ca. 4° C.) and thus the discharge gas stream removed from the fumigation chamber is already at a relatively low temperature. This low temperature is advantageous since the lower the temperature, the greater the affinity for the methyl bromide to become adsorbed on the adsorbent (e.g., carbon). While still lower temperatures would thus be even more advantageous with respect to the adsorption efficiency, the energy costs associated with cooling large volumes of fumigation aeration gases would render the process uneconomic.

The amount of adsorbent utilized should be selected to be sufficient to adsorb substantially all (e.g., at least 90% or at least 95% or even at least 99%) of the alkyl halide present in the first gas volume. The first gas volume may be recycled or otherwise brought into repeated contact with the adsorbent in order to reduce the alkyl halide concentration to the desired level. For example, the gas stream exiting the vessel containing a bed of the adsorbent may be recirculated back through the vessel one or more times, provided the adsorbent bed has sufficient capacity to ensure that the alkyl halide concentration does not rise to an unacceptable level. Typically, the alkyl halide-containing adsorbent contains from about 0.5 to about 5 weight percent alkyl halide.

Desorption of the alkyl halide adsorbed on the adsorbent is accomplished by contacting a volume of air with the alkyl halide-containing adsorbent. This volume of air is smaller (typically, much smaller) than the volume of the first gas volume (e.g., the desorption air volume may be less than 20% or less than 3% or less than 0.5%, but generally will be at least 0.1%, of the volume of the first gas volume). During the desorption air contacting, the temperature is maintained within a second temperature range that is greater than the first temperature range and effective to desorb at least a portion of the alkyl halide (preferably at least 70% and more preferably at least 85% or at least 99% of the alkyl halide) from the adsorbent, thereby producing a second gas volume containing the alkyl halide and having a volume less than the volume of the first gas volume and an alkyl halide concentration greater than the alkyl halide concentration of the first gas volume. Advantageously, the present process may be operated such that the second gas volume which is produced is less than 20% or less than 3% or even less than 0.5% of the volume of the first gas volume. Typically, however, the volume of the second gas volume is at least 0.1% of the volume of the first gas volume. It is convenient and advantageous to carry out such contacting by introducing a stream of air into a vessel containing the alkyl halide-containing adsorbent, allowing the air stream to pass over or through the adsorbent (for example, in an upflow or downflow manner), and then withdrawing the air stream containing the desorbed alkyl halide from the vessel to yield the second gas volume. During this contacting and desorption step, the outlet concentration of alkyl halide will generally be greater than the inlet alkyl halide concentration observed during the adsorption step. The withdrawn stream may be recycled back into contact with the alkyl halide-containing adsorbent so as to further decrease the amount of alkyl halide still retained on the adsorbent. As with the adsorption step, the optimum temperature for desorption will depend upon a number of variables, but typically the desorption temperature is at least 50° C., but no more than 300° C. (preferably, no more than 150° C.), higher than the adsorption temperature. In certain embodiments of the invention, the desorption temperature is less than 150° C., e.g., within the temperature range of 80 to 120° C. or within the temperature range of 90 to 110° C.

The step of contacting the second gas volume (containing desorbed alkyl halide) with a liquid phase comprising water and a nucleophile capable of reacting with the alkyl halide to produce a purified gas stream can be carried out using any suitable procedure. The contacting may be performed on either a batch or continuous basis. Preferably, the contacting is conducted in accordance with the methods described in published United States application No. 2006-0088462, incorporated herein by reference in its entirety.

For example, bubbles of gas may be passed through an aqueous solution of a nucleophile, optionally containing an organic compound, which has been found to increase the effectiveness of alkyl halide removal. The bubbles rise through the aqueous solution, during which time the alkyl halide is converted to relatively nonvolatile materials, which may then be collected for use or merely disposed of.

The invention will next be illustrated with reference to the figure. The figure is intended to be illustrative rather than limiting and is included herewith to facilitate the explanation of the present invention. The figure is not to scale, and is not intended to serve as an engineering drawing.

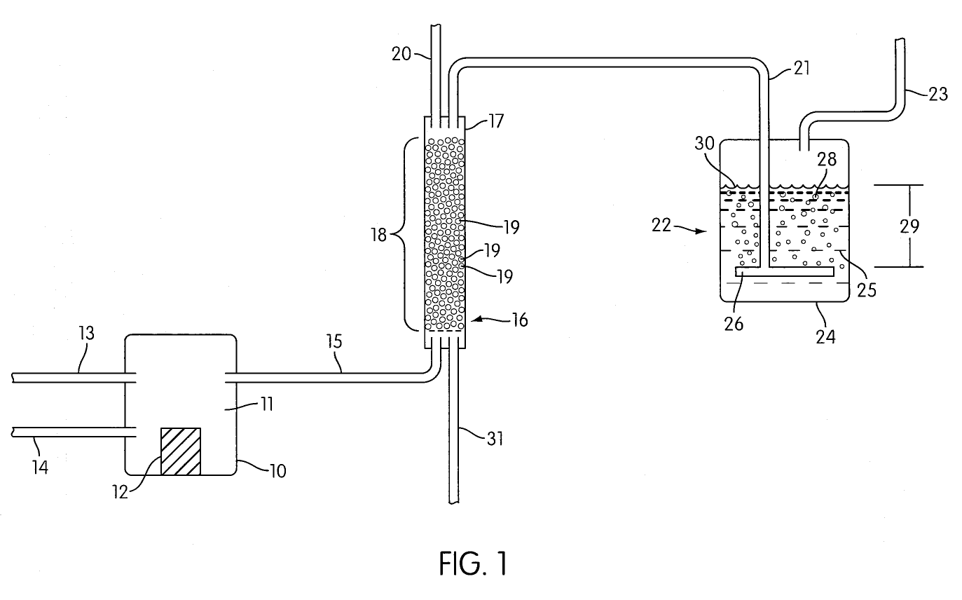

FIG. 1 shows in schematic form a system suitable for practicing the method of the present invention, according to one exemplary embodiment. FIG. 1 does not show all valves, pumps, blowers, flow meters, analyzers and the like which might be employed in such a system, but the skilled artisan will recognize from the following description that the placement and design of such features are flexible and that the system can readily be configured in many possible ways to achieve effective and satisfactory results. The system comprises an enclosure 10 defining a confined space 11 to be fumigated and capable of being sealed, such as a fumigation chamber. A product 12 requiring fumigation, such as a quantity of produce, is present within enclosure 10. Enclosure 10 is sealed and an amount of methyl bromide effective to fumigate the product is introduced via line 13 into enclosure 10 to produce a gaseous environment within confined space 11 comprised of air and methyl bromide. The gaseous environment is contacted with product 12 for a length of time effective to fumigate product 12 to the desired extent. Thereafter, fresh air is introduced into enclosure 10 via line 14 and the gaseous environment is withdrawn from enclosure 10 via line 15 to produce a first gas volume containing air and methyl bromide. The first gas volume comprises the gaseous environment as well as the fresh air used to flush residual methyl bromide from the enclosure 10.

The first gas volume may be passed directly into adsorption/desorption unit 16 or, alternatively, may be stored temporarily in a tank or other gas-containing structure prior to being introduced into adsorption/desorption unit 16. Adsorption/desorption unit 16 comprises a hollow column 17 containing a bed 18 of activated carbon particles 19. The first gas volume is permitted to flow through bed 18 under conditions effective to cause adsorption of the methyl bromide onto the activated carbon particles 19. For example, the temperature at which the first gas volume is contacted with the activated carbon particles is generally relatively low (e.g., less than 50° C., or within the range of −20 to 35° C., or at typical ambient or room temperatures). Temperature control within adsorption/desorption unit 16 may be effected by any suitable technique, such as employing a jacketed column cooled and/or heated by circulating water or other liquid or by directly heating or cooling a gas stream before it is introduced into the adsorption/desorption unit 16. The gas stream exiting from adsorption/desorption unit 16 via line 20 thus has a reduced concentration of methyl bromide as compared to the stream of the first gas volume entering the adsorption/desorption unit 16. If it is desired to limit the total volume of discharge gas removed from enclosure 10 or the amount of aeration air introduced into the system, the exiting gas stream can be introduced back into enclosure 10 to assist in sweeping out residual methyl bromide from confined space 11. In yet another embodiment of the invention, adsorption/desorption unit 16 is operated such that the exiting gas stream has a low enough concentration of methyl bromide such that it can safely be vented directly into the atmosphere. Although a single adsorption/desorption unit 16 is shown in FIG. 1, another embodiment of the present invention would be to use two or more such units which may be connected in parallel and/or in sequence (not shown).

Once adsorption of methyl bromide from the first gas volume onto the adsorbent has proceeded to the desired extent, desorption of the methyl bromide may be initiated by closing line 20, opening line 21 (leading to reactor assembly 22), and introducing a stream of fresh air or other gas having a suitably low methyl bromide concentration into adsorption/desorption unit 16 via line 31. The temperature of the bed 18 of activated carbon particles 19 is also increased to within a range effective to promote relatively rapid methyl bromide desorption. The fresh air stream is passed through bed 18 and thus brought into contact with activated carbon particles 19, which contain adsorbed methyl bromide. The desorption conditions (adsorption/desorption unit 16 temperature, gas flow rate, volume of fresh air introduced, etc.) are controlled such that a second gas volume is generated which contains methyl bromide in a concentration greater than that of the first gas volume and which also has a volume less than the volume of the first gas volume. In effect, by operation of the present invention, the relatively large gas volume generated by venting and purging the enclosure 10 containing methyl bromide in relatively diluted form is converted to a relatively small gas volume containing methyl bromide in relatively concentrated form. Thus, by concentrating the methyl bromide in a much smaller gas volume, equipment costs associated with gas handling and the size of the scrubber system that are directly proportional to the volume of gas being handled (and that are nearly independent of the methyl bromide concentration in the gas stream) are significantly reduced.

A stream containing the second gas volume is withdrawn from adsorption/desorption unit 16 via line 21 and delivered to reactor assembly 22. A purified gas stream exits from reactor assembly 22 through line 23. This purified gas stream may be recycled back to adsorption/desorption unit 16, or it may be released through a vent into the atmosphere (if the alkyl halide concentration is suitably low), or delivered into a product tank or other enclosure or into another reactor assembly (scrubber). By recycling the purified gas stream back through bed 18 in adsorption/desorption unit 16, a higher level of alkyl halide removal may be obtained. Although a single reactor assembly 22 is shown in FIG. 1, two or more may be used, and they may be connected in parallel and/or in series (not shown).

Reactor assembly 22 comprises a reaction vessel 24 containing a liquid phase 25. Reaction vessel 24 may be of any convenient shape and appropriate material of construction. In the embodiment shown in FIG. 1, the gas stream which comprises the second gas volume containing the desorbed methyl bromide passes into liquid phase 25 through a gas disperser 26, for example a glass frit that provides introduction of small bubbles of feed gas into the liquid to enhance the overall gas-liquid mass transfer rate. Other types of gas dispersers may also be used, for example a pipe with holes in it, or a plate with holes in it, or any other device known in the art to convert the gas stream into small bubbles. Bubbles 28 rise through a liquid column 29 through liquid phase 25 until they reach the upper surface 30 of liquid phase 25, during which time contact is made such that the alkyl halide can rapidly be carried into the liquid phase 25. It is preferred that the bubbles 28 be small, to maximize the gas-liquid surface area and thereby increase the rate at which alkyl halide is carried into liquid phase 25 to the point where gas-liquid mass transfer is not the rate-limiting step in the reaction of alkyl halide with nucleophile.

Suitably small bubbles may be provided by any means known in the art, but they are conveniently provided by the use of porous tubes (spargers) having pores between 1 and 200 microns across at their widest point. Typically, the pores will be between 10 and 50 microns across. In one embodiment, the majority of the pores are within the range specified. The holes are typically roughly circular in shape, although other shapes could be employed. The spargers are typically situated such that there is a relatively unobstructed or free flow of bubbles through the aqueous phase containing the nucleophile. If the bubbles collide with each other in a manner where they lose their individual integrity and thus coalesce and create larger bubbles, as is the case when the volume of gas passed through the sparger is too great or the spargers are too close to each other, significantly reduced removal efficiencies may be encountered due to the decreased mass transfer area of methyl bromide into the liquid phase. The design issue becomes providing enough gas-liquid contact area via the creation of small, finely divided bubbles to transfer significant amounts of reactive alkyl halide gas to the liquid phase. One of the factors determining the bubble size is the size of the pores in the sparger tubes. When the pores are too small the corresponding increased pressure drop may be very large thus requiring gas compression of large volumes of gas that unnecessarily increases the processing cost.

FIG. 1 does not show an agitator, although one may be used. However, the present invention does not require any mechanical stirring, but takes advantage of the turbulence created in the liquid phase due to the introduction of the gas through the small openings in the gas disperser(s). Liquid phase 25 may be recycled or discarded when the nucleophile has been depleted due to reaction with the alkyl halide. Liquid phase 25 may be discharged to a wastewater treatment plant (WWTP) suitably equipped to handle high dissolved salt concentrations. Regeneration or replenishment of the liquid phase may also be carried out, either periodically or continuously, by, for example, withdrawing portions of the liquid phase (after it has been contacted with the second gas volume) and introducing fresh amounts of nucleophile and possibly other components of the liquid phase to replace materials consumed by reaction with the alkyl halide contained in the second gas volume.

In some applications, for example where alkyl halide levels are to be reduced to an especially low level, it may be desirable to connect two or more reactor assemblies (scrubbers) in series, such that purified gases exiting a scrubber are further purified by subsequent passage through another. On the other hand, in some applications it may be desired to rapidly purify a large volume of gas, in which case two or more scrubbers may be used in parallel. Combinations of series and parallel arrangements may also be practiced according to the invention, using multiple scrubbers.

Typically, the distance 29 from the upper end of gas disperser 26 to upper surface 30 of the liquid phase 25 is at least 15 cm (6 inches) and more typically at least 31 cm (12 inches). The distance is typically at most 310 cm (120 inches) and more typically at most 244 cm (8 feet). However, greater liquid depths can be used, as long as the blower (or other device used to introduce the alkyl halide-containing gas stream into the liquid phase) has sufficient capacity to introduce gas at the desired flow rate and pressure. Thus, no real upper limit for liquid depth exists other than that resulting from blower capability, available space, and other practical limitations.

The inventors have found that the rate at which the gas stream enters the reactor assembly (scrubber) affects the degree of completeness with which the alkyl halide is consumed, with too high a rate tending to decrease the degree of alkyl halide destruction. One suitable measure of the rate of gas flow relative to the size of the scrubber is the superficial gas velocity, which may be calculated by dividing the volumetric flow rate of gas into the scrubber by the average cross-sectional area of the scrubber. An acceptable superficial gas velocity for a given situation depends inter alia upon the type and concentration of alkyl halide in the gas stream entering the scrubber, the type and concentration of nucleophile employed, the amount and type (if any) of soluble organic compound in the liquid phase, the size of the bubbles produced by the gas disperser(s), the distance that the bubbles travel through the liquid phase, the temperature of the liquid phase, and the desired level of alkyl halide removal from the gas stream. For example, when scrubbing methyl bromide from an air stream with thiosulfate in the presence of PEG 200, using a gas disperser having approximately 20-μm pores and a 31 cm (12-inch) travel of the resulting rising bubbles, a superficial gas velocity may typically be at most 75 cm/min (2.5 ft/min), and more typically will be in the range of 15 to 33 cm/min (0.5 to 1.1 ft/min).

The liquid phase contains water and at least one nucleophile, but may also include dissolved materials such as co-solvents, and of course products formed by the nucleophilic reaction of the alkyl halide and the nucleophile. The liquid phase is typically essentially free of suspended undissolved material, but this is not required. The term “nucleophile” as used herein means an anion or molecule having a high electron density which is accessible for reaction with another molecule by displacement of a leaving group, typically an anion such as halide. Due to the presence of a good leaving group (halide anion), alkyl halides can take part in nucleophilic substitution reactions with nucleophiles, such reactions typically (but not necessarily) being of the bimolecular (S_{N}2) type.

Many neutral and anionic nucleophiles can participate in nucleophilic substitution reactions with alkyl halide. A non-limiting list of anions suitable for use as nucleophiles according to the invention includes the following and their derivatives: cyanide (CN⁻), thiocyanate (SCN⁻), cyanate (OCN⁻), bisulfide (HS⁻), sulfide (S²⁻), carbonate (CO₃²⁻), bicarbonate (HCO₃⁻), thiocarbonates (monothio, dithio, and trithio), azide (N₃⁻), sulfite, bisulfite, alkyl, aryl, or aralkyl thiolate, nitrite, nitrate, phosphates (mono and di hydrogen phosphates plus phosphate), thiophosphates, biselenide (HSe⁻), selenide (Se²⁻), (substituted and non-substituted) benzenesulfonate, chloride, bromide, fluoride, iodide, thiosulfate, chlorate, hypochlorite, malonate, carboxylates such as trichloroacetate (CCl₃COO⁻), dichloroacetate, chloroacetate, terephthalate, adipate, lactate, m-chloroperbenzoate, formate, acetate, acrylate, propionate, butyrate, benzoate, furoate, oxalate, phthalate, hydrogen phthalate, silicates, bromate, periodate, performate, and phenolate, cresolate, and catecholate. Suitable neutral nucleophiles may include for example ammonia and primary, secondary, and tertiary amines, where the substituents on nitrogen may be any combination of alkyl, aryl, and aralkyl groups, and phosphines analogous to such amines. In this context, the term “derivative” means a compound that contains one of the nucleophilic groups listed above.

Particularly suitable nucleophiles for use according to the invention include compounds containing sulfur or nitrogen at the nucleophilic center. As used herein, the term “nucleophilic center” means that atom which becomes bonded to the alkyl halide residue by virtue of the nucleophilic reaction. Specific examples of suitable sulfur nucleophiles include aliphatic and, preferably, aromatic thiols and their salts, aliphatic and aromatic disulfides and polysulfides, sulfide anion, bisulfide anion, thiosulfate anion, sulfite or bisulfite anion, and thiocyanate anion. In one exemplary embodiment of the invention, the nucleophile comprises at least one of sodium sulfide and sodium bisulfide at a concentration of from about 0.1 wt % to the saturation limit in the liquid phase. When sulfur nucleophiles are used, it may be advantageous to oxidize the resulting reaction products, for example with sodium hypochlorite, to convert them to materials having less odor.

Other suitable nucleophiles are alkoxides, carboxylates, hydroxide, and selenium analogs of sulfur nucleophiles.

When a precursor species must be ionized to become a highly reactive nucleophile, for example when a hydroxy compound or thiol or carboxylic acid must be converted to the corresponding anion, a pH-adjusting agent is used in such an amount as to ensure that the pH is raised to a level sufficient to ionize the chemical species, namely by removing a proton from the species and generating a negatively charged species in the liquid phase. The required pH is dependent on the nature of the nucleophile, namely whether its conjugate acid is a strong or weak acid. For example, if the nucleophile is the anion of a weak acid, a relatively higher pH may be required in order to produce a sufficient concentration of the anion. Conversely, when the chemical species already exists as a nucleophilic anion or as a neutral compound that can act as a nucleophile, no pH-adjusting agent may be needed. When a pH adjusting agent is needed, the particular amount of the agent or base will vary depending on process conditions, but can be optimized easily by altering the concentration and determining its effect on yield, bearing in mind the ranges of excess molar concentrations set forth above.

According to the present invention, a pH-adjusting agent (if needed to produce suitable quantities of nucleophile) is used in an amount sufficient to provide an excess molar concentration of base in the range between −0.99 and 1.0, preferably between −0.25 and 0.5, more preferably between stoichiometric and 0.25, and most preferably between 0.01 and 0.1. As used herein, the term “stoichiometric” means the amount of base indicated by a balanced chemical equation to be necessary to convert all of the precursor species to the desired nucleophile. Thus, the “excess molar concentration of base” is the amount of base actually in the system above that which would be stoichiometrically required to neutralize ionizable hydrogen atoms, and is expressed herein as the difference between the actual concentration of base and the stoichiometric concentration divided by the stoichiometric concentration. Thus, a negative value of excess molar concentration of base contemplates that less than the stoichiometric amount of base is used.

A suitable pH for purposes of the invention is one at which a nucleophilic anion is present and is at least partially soluble in the liquid phase, typically from pH 7 to 13.5. However, certain embodiments of the present invention may provide sufficient amounts of nucleophile even at lower pH values, even as low as a pH of about 1, depending on the nucleophile used.

It should be recognized that the pH as used herein refers to the pH in the liquid phase. The pH adjusting agent may be added to the liquid phase prior to contacting the gas stream containing alkyl halide, or afterwards. Any of a number of suitable pH adjusting agents may be used, but some typical ones are sodium hydroxide, potassium hydroxide, magnesium hydroxide, calcium hydroxide, lithium hydroxide, ammonium hydroxide, magnesium carbonate, calcium carbonate, tetraalkyl ammonium hydroxides, sodium and potassium carbonates, bicarbonates, phosphates, similar salts, and mixtures thereof.

The liquid phase may also contain a water-soluble organic compound, and the presence of such compounds has been found in some cases to increase the rate and/or completeness of alkyl halide destruction. For example, the addition of water soluble organic compounds such as N-methylpyrrolidone, dimethyl formamide, dimethyl sulfoxide (DMSO), and poly(ethylene glycol) to the water phase has been shown to improve the level of removal of methyl bromide. Without wishing to be bound by any particular theory or explanation, it is believed that the water soluble organic compound increases alkyl halide solubility by decreasing the polarity of the liquid phase, and that this increases the rate of reaction between the alkyl halide and the nucleophile. Water-soluble organic compounds may constitute between 1 and 99 wt % of the liquid phase, more typically between 1 and 25 wt %. In some embodiments, the organic compound is relatively nonvolatile, by which is meant it does not boil below 125° C. In some embodiments of the invention, the organic compound is a polyglycol according to the formula H—(OCH₂CHR)ₙ—OH, wherein n is an integer from 1 to 20 and R is H or CH₃. One useful example is tetraethylene glycol.

Preferred nucleophilic reaction conditions for the destruction of alkyl halides depend on a number of factors, including the specific nucleophilic species used, and the organic substrate used. In general, the time and temperature should be selected to cause the reaction to proceed rapidly. As is well known, the choice of temperature is dictated by the kinetics of the reaction and the solubility of alkyl halide in the reaction medium. Reactions that occur more slowly are preferably run at higher temperatures. Lower reaction temperatures may however be suitable or even preferable in some situations, provided only that the reaction rate of alkyl halide be sufficiently fast to achieve the desired degree of removal. Typical suitable temperatures are from −3° C. to 105° C., more typically from 2 to 40° C., and most typically from 5 to 30° C.

The reactor assembly (scrubber) may be run at approximately atmospheric pressure, i.e., atmospheric pressure plus the incremental additional pressure generated by the head of liquid over the gas disperser(s). It may also be operated at pressures well above atmospheric, and there is no known limit to how high a pressure may be used provided that the safety of the processing equipment is not compromised by pressures that exceed manufacturers' recommendations. Higher pressures may increase the rate of reaction, and may be especially useful in cases where there is a relatively high concentration of alkyl halide and a correspondingly lower level of diluent gas (e.g., air) in the feed, since the cost of compressing and decompressing the feed may be less in such a situation. Higher pressures may also be beneficial when a higher scrubber reaction temperature is desired, with the higher pressure making it possible to reduce loss of water or other volatile components.

In one embodiment of the invention, the adsorption and desorption steps may be repeated at least once so as to even further concentrate the alkyl halide prior to introducing the gas stream containing the alkyl halide into the reactor assembly (i.e., prior to contacting such gas stream with the liquid phase comprising water and one or more nucleophiles). For example, the following series of steps may be practiced:

a first gas volume containing an alkyl halide is provided;

the first gas volume is contacted with a first portion of an adsorbent capable of adsorbing the alkyl halide from the first gas volume within a first temperature range, thereby producing a first alkyl halide-containing adsorbent;

a first volume of air that is smaller in volume than the first gas volume is contacted with the first alkyl halide-containing adsorbent within a second temperature range that is greater than the first temperature range and effective to desorb at least a portion of the alkyl halide from the first portion of adsorbent, thereby producing a second gas volume containing the alkyl halide and having a volume less than the volume of the first gas volume and an alkyl halide concentration greater than the alkyl halide concentration of the first gas volume;

the second gas volume is contacted with a second portion of an adsorbent capable of adsorbing the alkyl halide within a third temperature range, thereby producing a second alkyl halide-containing adsorbent;

a second volume of air that is smaller in volume than the first volume of air is contacted with the second alkyl halide-containing adsorbent within a fourth temperature range that is greater than the third temperature range and effective to desorb at least a portion of the alkyl halide from the adsorbent, thereby producing a third gas volume containing the alkyl halide and having a volume less than the volume of the second gas volume and an alkyl halide concentration greater than the alkyl halide concentration of the second gas volume; and

the third gas volume is contacted with a liquid phase comprising water and a nucleophile capable of reacting with the alkyl halide to produce a purified gas stream.

### EXAMPLES

The adsorption and desorption steps of the method of the present invention are demonstated by the following example.

A stainless steel insulated column that is 2.5 cm in diameter was filled with activated carbon particles to a depth of 127.4 cm (carbon charge=311.8 g; carbon density=0.457 kg/m³). Temperature control within the column was maintained with circulating and pressurized hot water in an external heat exchanger jacket that enveloped the full length of the carbon bed. The inlet, outlet and jacket temperatures were measured with 3-wire RTDs. Inlet and outlet temperature probes were welded into the pipe so that they protruded directly into the gas streams. A jacket temperature probe was placed on the surface of the jacket, underneath a layer of fiberglass insulation. Adsorption and desorption air flow rates were measured using factory calibrated mass flow meters (Cole-Parmer). The outlet concentration of methyl bromide in air was measured using infrared absorption with a methyl bromide analyzer supplied by Spectros Instruments (Hopedale, Mass.). Calibration gas standards of 1.50. 0.76 and 0.18 volume percent methyl bromide in air (Scott-Marin, Riverside, Calif.) were used to check the calibration of the IR analyzer. Using the mass flow meters, the calibration standards were fed to the column in a manner to simulate the exponential concentration decay flow loading of methyl bromide onto the carbon column (inlet gas concentration to the carbon bed was based on a typical exponentially decaying feed stream exiting a fumigation chamber). All of these instruments were connected to a National Instruments Labview® data acquisition system connected to a personal computer. Data points for all instruments were taken every 30 seconds and recorded for both the adsorption and desorption steps.

During the adsorption step, the mass of methyl bromide loaded on the carbon column was obtained by summing the flow rate provided by the mass flow meters times the known feed concentration while the methyl bromide was being fed to the column. During the desorption step, the mass of methyl bromide removed was obtained by summing the flow rate times the concentration of methyl bromide provided by the IR analyzer, with the latter being obtained every 30 seconds over 16 hours (ca. 1900 data points).

Temperature control of the column was not used during the adsorption step, such that the feed stream containing methyl bromide contacted the activated carbon particles at ambient temperatures. During the desorption step, the inlet and outlet temperatures were controlled to within 98.5 to 101° C. by the recirculating pressurized hot water system. The desorption cycle time was approximately 4 times longer than the adsorption cycle time.

Table 1 shows the data measured for two corresponding adsorption and desorption cycles.

TABLE 1

| | Run No. 1 | Run No. 2 |
|---|---|---|
| Adsorption | | |
| Grams Methyl Bromide Loaded | 7.78 | 7.73 |
| Loading, % | 2.50 | 2.48 |
| Temperature, ° C. | 16.2 | 17.8 |
| Time, hours | 4.0 | 4.0 |
| Desorption | | |
| Grams Methyl Bromide | 7.50 | 7.49 |
| Removed | | |
| Temperature, ° C. | 98.5 | 101.0 |
| Time, hours | 16.2 | 15.1 |
| Mass Balance (Out/In × 100) | 96.4% | 96.9% |

Although the invention is illustrated and described herein with reference to specific embodiments, the invention is not intended to be limited to the details shown. Rather, various modifications may be made in the details within the scope and range of equivalents of the claims without departing from the invention.

What is claimed is:

1. A method of removing an alkyl halide from a first gas volume, the method comprising:
contacting the first gas volume with an adsorbent capable of adsorbing the alkyl halide from the first gas volume within a first temperature range, thereby producing an alkyl halide-containing adsorbent;
contacting a volume of air that is smaller than the first gas volume with the alkyl halide-containing adsorbent within a second temperature range that is greater than the first temperature range and effective to desorb at least a portion of the alkyl halide from the adsorbent, thereby producing a second gas volume containing the alkyl halide and having a volume less than the volume of the first gas volume and an alkyl halide concentration greater than the alkyl halide concentration of the first gas volume; and
contacting the second gas volume with a liquid phase comprising water and a nucleophile capable of reacting with the alkyl halide to produce a purified gas stream.

2. The method of claim 1, wherein the first temperature range is from −20 to 35° C.

3. The method of claim 1, wherein the second temperature range is from 80 to 120° C.

4. The method of claim 1, wherein the second temperature range is not greater than 300° C.

5. The method of claim 1, wherein the adsorbent comprises activated carbon particles.

6. The method of claim 1, wherein the first gas volume is comprised of air and the alkyl halide.

7. The method of claim 1, wherein the volume of the second gas volume is less than 5% of the volume of the first gas volume.

8. The method of claim 1, wherein at least 95% of the alkyl halide present in the first gas volume is adsorbed by the adsorbent.

9. The method of claim 1, wherein the contacting of the first gas volume with the adsorbent and the contacting of the volume of air with the alkyl halide-containing adsorbent are carried out within a vessel and the vessel is not transported between the contacting steps.

10. The method of claim 1, wherein the first gas volume is generated by providing an enclosure defining a confined space to be fumigated, placing a product within the enclosure, sealing the enclosure, introducing an amount of the alkyl halide effective to fumigate the product into the enclosure to produce a gaseous atmosphere comprised of air and alkyl halide, allowing the gaseous atmosphere to remain in contact with the product for a length of time effective to fumigate the product to a desired extent, and flushing the gaseous atmosphere from the enclosure using additional air.

11. The method of claim 1, wherein the nucleophile is selected from the group consisting of aliphatic thiols, aromatic thiols, salts of aromatic thiols, salts of Is aliphatic thiols, aliphatic disulfides, aliphatic polysulfides, aromatic polysulfides, aliphatic polysulfides, sulfide anion, bisulfide anion, thiosulfate anion, sulfite anion, bisulfite anion, and thiocyanate anion.

12. The method of claim 1, wherein the contacting of the second gas volume with the liquid phase is carried out by bubbling the second gas volume into the liquid phase.

13. The method of claim 1, wherein the contacting of the second gas volume with the liquid phase is carried out by passing the second gas volume through one or more gas dispersers having therein a plurality of holes, thereby producing gas bubbles, and passing the gas bubbles through the liquid phase.

14. The method of claim 1, wherein the liquid phase further comprises between 1 and 25 wt % of an organic compound dissolved therein.

15. The method of claim 14, wherein the organic compound is a polyethylene glycol.

16. A method of removing an alkyl halide from a first gas volume, the method comprising:
contacting the first gas volume with a first portion of an adsorbent capable of adsorbing the alkyl halide within a first temperature range, thereby producing a first alkyl halide-containing adsorbent;
contacting a first volume of air that is smaller in volume than the first gas volume with the first alkyl halide-containing adsorbent within a second temperature range that is greater than the first temperature range and effective to desorb at least a portion of the alkyl halide from the first portion of adsorbent, thereby producing a second gas volume containing the alkyl halide and having a volume less than the volume of the first gas volume and an alkyl halide concentration greater than the alkyl halide concentration of the first gas volume;
contacting the second gas volume with a second portion of an adsorbent capable of adsorbing the alkyl halide within a third temperature range, thereby producing a second alkyl halide-containing adsorbent;
contacting a second volume of air that is smaller in volume than the second gas volume with the second alkyl halide-containing adsorbent within a fourth temperature range that is greater than the third temperature range and effective to desorb at least a portion of the alkyl halide from the adsorbent, thereby producing a third gas volume containing the alkyl halide and having a volume less than the volume of the second gas volume and an alkyl halide concentration greater than the alkyl halide concentration of the second gas volume; and
contacting the third gas volume with a liquid phase comprising water and a nucleophile capable of reacting with the alkyl halide to produce a purified gas stream.

17. A system for removing an alkyl halide from a gas volume, the system comprising:
a) an adsorption/desorption unit comprising an adsorbent capable of adsorbing the alkyl halide from the gas volume; and
b) a reactor assembly comprising a reaction vessel containing a liquid phase comprised of water and at least one nucleophile.

18. The system of claim 17, wherein the adsorption/desorption unit comprises a hollow column containing a bed of the adsorbent in particulate form.

19. The system of claim 17, wherein the adsorption/desorption unit and the reactor assembly are connected by a line capable of transferring a gas stream from the adsorption/desorption unit to the reactor assembly.

20. The system of claim 17, further comprising an enclosure defining a confined space and capable of being sealed, the enclosure being connected to the adsorption/desorption unit by a line capable of transferring a gas stream from the enclosure to the adsorption/desorption unit.

21. The system of claim 17, wherein the reactor assembly further comprises one or more gas dispersers having therein a plurality of holes, the one or more dispersers being immersed in the liquid phase.
